(19) United States
(12) Patent Application Publication
(10) Pub. No.: US 2010/0064318 A1
(43) Pub. Date: Mar. 11, 2010

(54) ELECTRONIC DEVICE AND DISPLAY METHOD THEREOF

(75) Inventor: Yuan-Chang TSOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/406,053

(22) Filed: Mar. 17, 2009

(30) Foreign Application Priority Data
Sep. 5, 2008 (CN) 200810304392.5

(51) Int. Cl. H04N 5/445

(52) U.S. Cl. 725/39

(57) ABSTRACT

An electronic device provides an electronic program guide, viewable on a screen providing a plurality of display areas. The electronic program guide includes a plurality of first options, a main option, and a plurality of second options. When one of the first options is selected, first sub-options of the selected first option are displayed on a first display area, the first options are moved from the first to a second display area, and the main option is moved from the second to a third display area. When a second option is selected, second sub-options of the selected second option are displayed on the third display area, the second options are moved from the third to the second display area, and the main option is moved from the second to the first display area.

### BACKGROUND

1. Technical Field

Embodiments of the present disclosure relate to television, and particularly to an electronic device providing an electronic program guide (EPG) and a display method thereof.

2. Description of Related Art

An electronic program guide (EPG) provided by an electronic device generally provides a primary user interface by which a user interacts with digital broadcast service, and can provide significant convenience in navigation of available channels.

Convenient designs of EGP greatly affect value and acceptance of the electronic device utilizing the EPG, such as set-top boxes. Many EPGs currently employ plane changing pages as an interaction interface. However, the plane changing pages can be considerably inconvenient in use.

To improve user experience, changes in presentation methods replacing the plane changing pages are desirable.

### BRIEF DESCRIPTION OF THE DRAWINGS

FIGS. 1-4 are schematic diagrams of an electronic program guide (EPG) provided by a first embodiment of an electronic device and a display method thereof as disclosed; and

FIGS. 5-7 are schematic diagrams of an EPG provided by a second embodiment of an electronic device and a display method thereof as disclosed.

### DETAILED DESCRIPTION OF THE DISCLOSURE

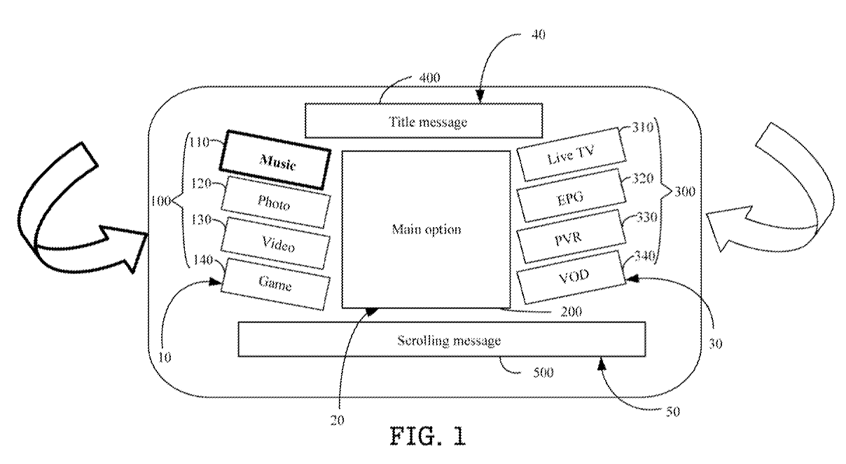

FIGS. 1-4 are schematic diagrams of a first embodiment of an electronic device providing an electronic program guide (EPG) and a display method thereof as disclosed. The electronic device can be any manifestation of a video & audio provider, such as a set-top box (STB), a digital television, a digital video recorder, a digital video disk (DVD) player, a mobile phone, a personal digital assistant (PDA), and others.

Referring to FIG. 1, the electronic device as disclosed provides an EPG, viewable on a screen providing a plurality of display areas. The plurality of display areas includes a first display area 10, a second display area 20, and a third display area 30 sequentially arranged from left to right of the screen. The EPG includes a plurality of first options 100, a main option 200, and a plurality of second options 300 respectively displayed on the first display area 10, the second display area 20, and the third display area 30.

The main option 200 may be a video file. The plurality of first options 100 may include files containing a music file 110, a photo file 120, a video file 130, and a game file 140. The music file 110 is selected by a user. The plurality of second options 300 may include live TV 310, EPG 320, personal video recorder (PVR) 330, and video-on-demand (VOD) 340 applications. Alternatively, the main option 200, the plurality of first options 100, and the plurality of second options 200 may include other options according to different designs or requirements.

The plurality of display areas provided by the screen may further include a fourth display area 40 and a fifth display area 50. The first display area 10, the fifth display area 50, the third display 30, and the fourth display area 40 are sequentially displayed along four sides of the second display area 20. The EPG may further include a title message 400 in the fourth display area 40 and a scrolling message 500 in the fifth display area 50.

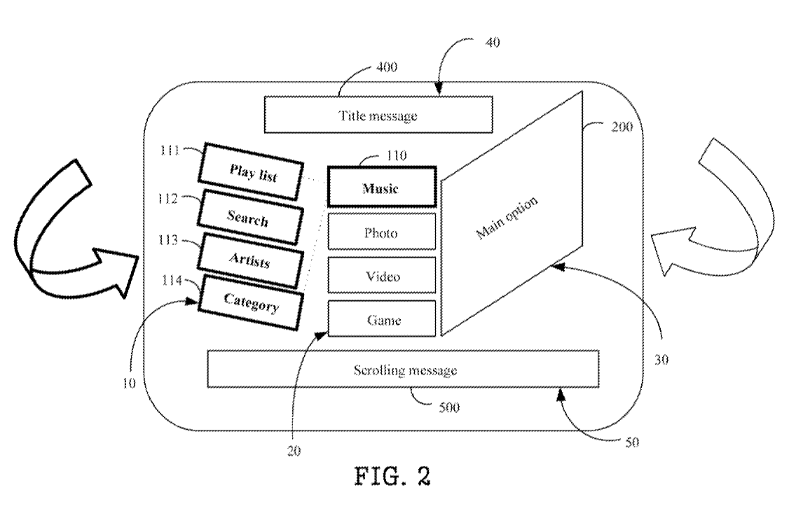

Referring to FIG. 2, each of the first options 100 includes a plurality of first sub-options that can be displayed on the first display area 10 when a corresponding first option 100 is selected. The first sub-options of the selected first option 100 are displayed on the first display area 10, and the plurality of first options 100 is moved from the first display area 10 to the second display area 20, and the main option 200 is moved from the second display area 20 to the third display area 30. Here the method of moving an option from one display area to another includes one option rotating from one display area to another display area.

For example, the music file 110 can include a play list 111, a search engine 112, an artist list 113, and category information 114. When the music file 110 is selected, the play list 111, the search engine 112, the artist list 113, and the category information 114 are displayed on the first display area 10, and the music file 110, the photo file 120, the video file 130, and the game file 140 are moved from the first display area 10 to the second display area 20, and the main option 200 is moved from the second display area 20 to the third display area 30.

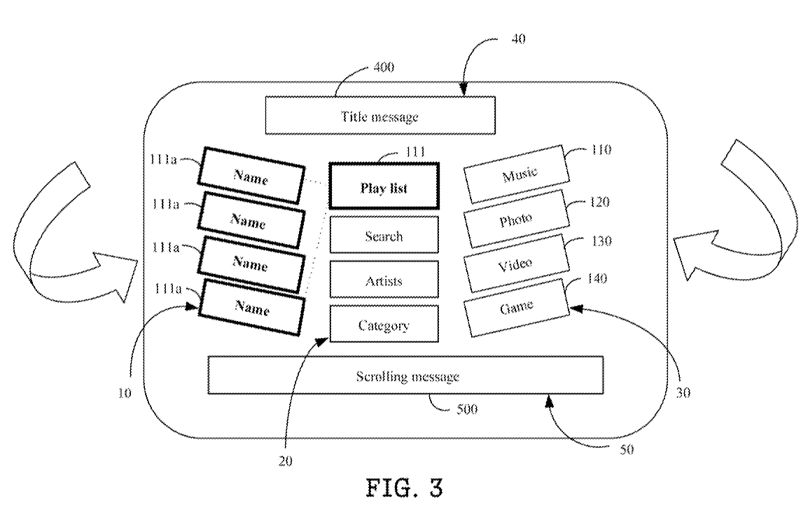

Referring to FIG. 3, each of the first sub-options includes at least one first supersub-option. When one of the first sub-options is selected, the at least one first supersub-option of the selected first sub-option is displayed on the first display area 10, the selected first sub-option is subsequently moved from the first display area 10 to the second display area 20, and the plurality of first options 100 are subsequently moved from the second display area 20 to the third display area 30.

For example, the play list 111 can include a plurality of names 111a. When the playlist 111 is selected, the plurality of names 111a are displayed on the first display area 10, the play list 111, the search engine 112, the artist list 113, and the category information 114 are subsequently moved from the first display area 10 to the second display area 20, and the music file 110, the photo file 120, the video file 130, and the game file 140 are subsequently moved from the second display area 20 to the third display area 30.

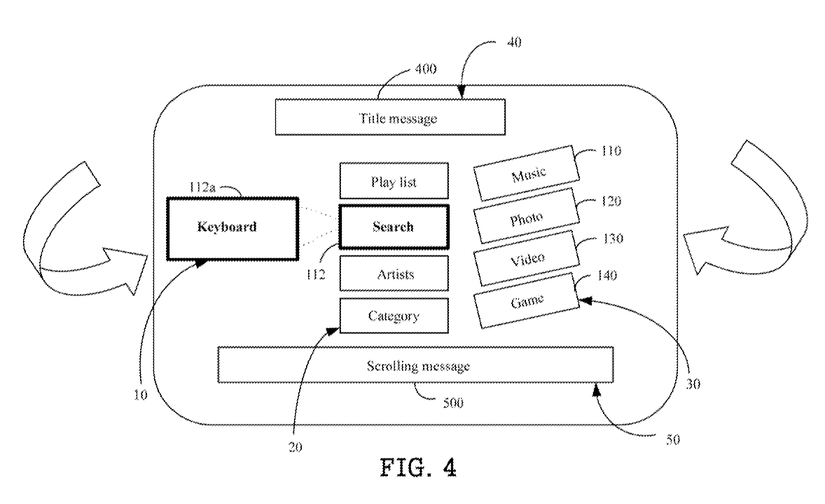

Referring to FIG. 4, when the search engine 112 is selected, a keyboard 112a is displayed on the first display area 10, accepting input from a user. Search results relating to the received name are displayed on the first display area 10.

In the same way, other first sub-options may also be selected, with according first supersub-options thereof displayed on the first display area 10.

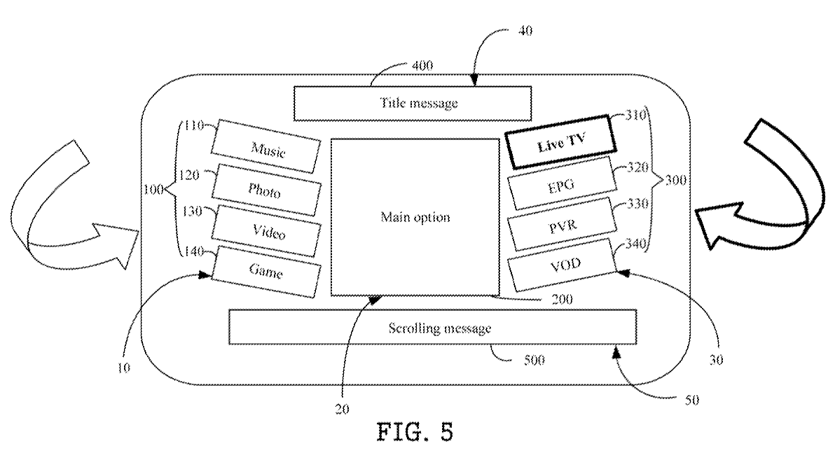

FIGS. 5-7 are schematic diagrams of a second embodiment of an electronic device providing an electronic program guide and a display method thereof, differing from the previous embodiment only in that the live TV 310 is selected.

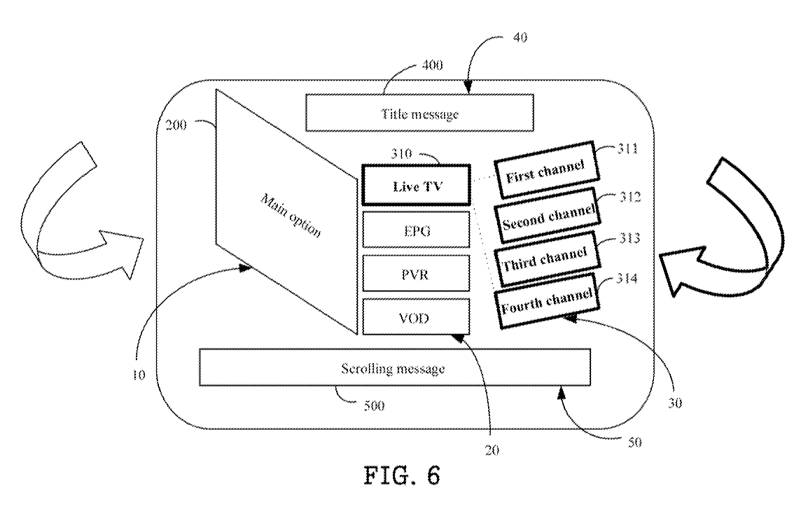

Referring to FIG. 6, each of the second options 300 includes a plurality of second sub-options that can be displayed on the third display area 30 when a corresponding second option 300 is selected, with corresponding second sub-options thereof displayed on the third display area 30, and the plurality of second options 300 is moved from the third display area 30 to the second display area 20, and the main option 200 is moved from the second display area 20 to the first display area 10. An example of a method of moving an option from one display area to another can include the option rotating from one display area to another.

For example, here, the live TV 310 receives a first channel 311, a second channel 312, a third channel 313, and a fourth channel 314. When the live TV 310 application is selected, the first channel 311, the second channel 312, the third channel 313, and the fourth channel 314 are displayed on the third display area 30, the live TV 310, the EPG 320, the PVR 330, and the VOD 340 are moved from the third display area 30 to the second display area 20, and main option 200 is moved from the second display area 20 to the first display area 10.

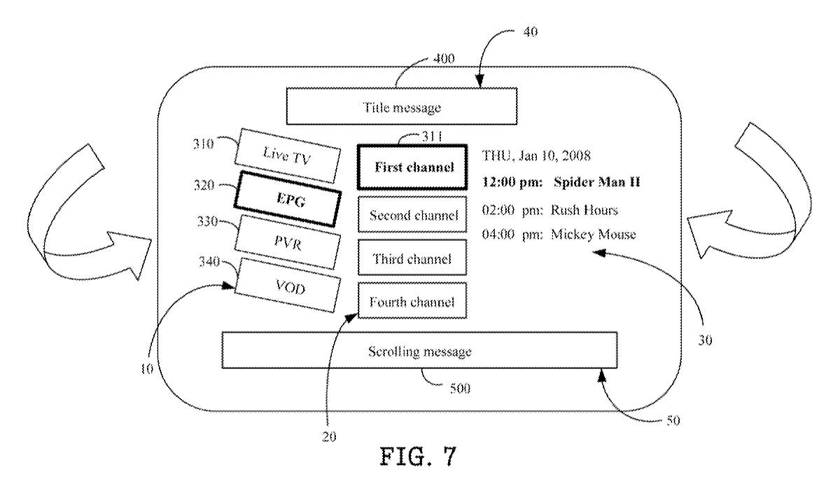

Referring to FIG. 7, each of the second sub-options includes at least one second supersub-option. When one second sub-option is selected, the at least one second supersub-option thereof is displayed on the third display area 30, and the selected second sub-option is subsequently moved from the third display area 30 to the second display area 20, and the plurality of first options 300 is subsequently moved from the second display area 20 to the first display area 10.

In an example, the first channel 311 carries programs such as Program A at 12:00 pm, Program B at 02:00 pm, Program C at 04:00, and others. When the first channel 311 is selected, titles and start times of the programs of the first channel 311 are displayed on the third display area 30. A program currently showing, such as, here, Program A, starting at 12:00 pm is tagged. If the current time is selected, the EPG will display in a full screen resolution, showing the currently playing. If a time other than the current time is selected, the corresponding program is reserved, and automatically shown at the selected time. When the first channel 311 is selected, displays of the first channel 311, the second channel 312, the third channel 313, and the fourth channel 314 are subsequently moved from the third display area 30 to the second display area 20, and the live TV 310, the EPG 320, the PVR 330, and the VOD 340 are subsequently moved from the second display area 20 to the first display area 10.

In the same way, other second sub-options may also be selected, at which time second supersub-options corresponding thereto may be displayed on the third display area 30.

Thus, the disclosed electronic device providing an electronic program guide and the display method thereof employ rotating pages to replace plane changing pages, increasing convenience. In addition, simultaneous display of at least three level options, such as simultaneously displaying the first option, the first sub-option, and the first supersub-options, further enhances user experience.

While various embodiments and methods of the present disclosure have been described, it should be understood that they have been presented by way of example only and not by way of limitation. Thus the breadth and scope of the present disclosure should not be limited by the described embodiments, but should be defined only in accordance with the following claims and their equivalents.

What is claimed is:

1. An electronic device providing an electronic program guide configured for display on a screen providing a plurality of display areas, the electronic program guide comprising:
a plurality of first options displayed on a first display area, each of the first options comprising a plurality of first sub-options that can be displayed on the first display area when a corresponding first option is selected;
a main option displayed on a second display area;
a plurality of second options displayed on a third display area, each of the second options comprising a plurality of second sub-options that can be displayed on the third display area when a corresponding second option is selected;
wherein when one of the first options is selected, the first sub-options of the selected first option are displayed on the first display area, the plurality of first options are moved from the first to the second display area, and the main option is moved from the second to the third display area;
wherein when a second options is selected, the second sub-options of the selected second option are displayed on the third display area, the plurality of second options are moved from the third to the second display area, and the main option is moved from the second to the first display area.

2. The electronic device of claim 1, further comprising a title message displayed on a fourth display area and a scrolling message displayed on a fifth display area, wherein the first, fifth, third, and fourth display areas are configured around the second display area.

3. The electronic device of claim 1, wherein each of the first sub-options comprises at least one first supersub-option.

4. The electronic program guide of claim 3, wherein when one of the first sub-options is selected, the corresponding at least one first supersub-option is displayed on the first display area, the selected first sub-option is subsequently moved from the first to the second display area, and the plurality of first options are subsequently moved from the second to the third display area.

5. The electronic device of claim 1, wherein each of the second sub-options comprises at least one second supersub-option.

6. The electronic program guide of claim 5, wherein when one of the second sub-options is selected, the corresponding at least one second supersub-option is displayed on the third display area, the selected second sub-option is subsequently moved from the third to the second display area, and the plurality of second options are subsequently moved from the second to the first display area.

7. An electronic program guide display method comprising:
providing a plurality of display areas;
displaying a plurality of first options on a first display area, each of the first options comprising a plurality of first sub-options;
displaying a main option on a second display area;
displaying a plurality of second options on a third display area;
selecting one of the first options;
displaying the first sub-options of the selected first option on the first display area;
moving the plurality of first options from the first to the second display area; and
moving the main option from the second to the third display area.

8. The electronic program guide display method of claim 7, further comprising:
displaying a title message on a fourth display area; and
displaying a scrolling message on a fifth display area, wherein the first, fifth, third, and fourth display areas are configured around the second display area.

9. The electronic program guide display method of claim 7, wherein each of the first sub-options comprises at least one first supersub-option.

10. The electronic program guide display method of claim 9, further comprising:
selecting one of the first sub-options;
displaying the at least one first supersub-option of the selected first sub-option on the first display area;
moving the selected first sub-option from the first to the second display area; and
moving the plurality of first options from the second to the third display area.

11. The electronic program guide display method of claim 7, wherein each of the second options comprises a plurality of second sub-options.

12. The electronic program guide display method of claim 11, further comprising:
selecting a second option;
displaying the second sub-options of the selected second option on the third display area;
moving the plurality of second options from the third to the second display area; and
moving the main option from the second to the first display area.

13. The electronic program guide display method of claim 12, wherein each of the second sub-options comprises at least one second supersub-option.

14. The electronic program guide display method of claim 13, further comprising:
selecting one of the second sub-options;
displaying the at least one second supersub-option of the selected second sub-option on the third display area;
moving the selected second sub-option from the third to the second display area; and
moving the plurality of second options from the second to the first display area.
